(19) United States
(12) Patent Application Publication
(10) Pub. No.: US 2002/0014842 A1
(43) Pub. Date: Feb. 7, 2002

(54) HIGH-PRESSURE DISCHARGE LAMP

(76) Inventors: MAKOTO HORIUCHI, NARA-KEN (JP); KIYOSHI TAKAHASHI, OSAKA-FU (JP); MAKOTO KAI, OSAKA-FU (JP)

Correspondence Address: WENDEROTH LIND & PONACK, 2033 K STREET N W, SUITE 800, WASHINGTON, DC, 20006

(21) Appl. No.: 09/157,244

(22) Filed: Sep. 18, 1998

(30) Foreign Application Priority Data
Mar. 14, 1996 (JP) 8-57486

(51) Int. Cl. H01J 17/04; H01J 61/04; H01J 17/20; H01J 61/12

(52) U.S. Cl. 313/631; 313/632; 313/634; 313/637

(57) ABSTRACT

A high-pressure discharge lamp is configured to regulate the relationship between the radius r (mm) of the tungsten rods forming the electrodes and the lamp current I (amperes) using the formula

$$1.5 \leq \frac{I}{π \cdot {r}^{2}} \leq 9$$

when the ratio of the circumference of the circle to its diameter is expressed as π. The high-pressure discharge lamp suppresses early blackening, and achieves a long-life light source.

### BACKGROUND OF THE INVENTION

1. Field of the Invention

The present invention relates to a high-pressure discharge lamp, which exhibits little blackening.

2. Description of the Related Art

In general, a high-pressure discharge lamp is a light source, which provides a pair of electrodes inside a translucent quartz arc tube filled with a noble gas for starting, and mercury or another metallic halogen compound, and which is designed so that an arc discharge is generated by applying voltage to both electrodes and creating a current. This arc discharge illuminates the filling substance, enabling the high-pressure discharge lamp to be widely used as ordinary lighting, or as lighting for such equipment as an overhead projector (OHP).

A metallic halogen compound-filled metal halide lamp features especially high efficiency and high color rendering capabilities. For this reason, it has recently come into widespread use in combination with a reflecting mirror in liquid crystal projectors and other such image projecting devices. And for this type of metal halide lamp, as disclosed in Japanese Patent Laid-Open Publication No. 3-219546, for example, an iodide of neodymium (Nd), dysprosium (Dy) and cesium (Cs) is generally used as the metallic halogen compound contained in the arc tube.

A lamp containing an iodide of neodymium (Nd), dysprosium (Dy) and cesium (Cs) (hereafter referred to as a Dy-Nd-Cs-I lamp) features outstanding luminous efficacy and color rendering, color temperature, but due to the strong reaction between neodymium (Nd) and the quartz in the arc tube, devitrification of the arc lube occurs during early life. Because this type of devitrification decreases luminous flux, reduces luminance and causes light to diffuse, it brings about uneven illuminance and reduced brightness in a liquid crystal projector screen. That is, when a Dy-Nd-Cs-I lamp is used as the light source in a liquid crystal projector, good light generation characteristics are achieved, but the drawback is short lamp life.

To counter this, as is disclosed in Japanese Patent Laid-Open Publication No. 2-186552, a method for filling the arc tube with lutetium (Lu), which does not readily react with quartz, has already been reported. That is, devitrification can be decreased and a metal halide lamp with good light generating characteristics can be achieved by filling an arc tube with mercury and noble gas, and between 2×10⁻⁷ mol/cc and 2×10⁻⁵ mol/cc of lutetium (Lu) together with halogen.

Recently, because metal halide lamps used in liquid crystal projectors and other image projection devices are being combined with optical systems, which utilize liquid crystals, it is desirable to enhance optical efficiency by further shortening the arc length (distance between electrodes).

However, when the arc length is shortened, the thermal burden on the electrodes increases, giving rise to early blackening of the arc tube, and causing a dramatic drop in the luminous flux maintenance factor. That is, a lamp with a short arc length is disadvantageous in that the arc tube blackens and luminous flux decreases even sooner than with the arc tube devitrification phenomenon, even when filled with a substance that does not readily react with quartz.

### SUMMARY OF THE INVENTION

An object of the present invention is to solve for this problem by providing a high-pressure discharge lamp that exhibits little blackening.

To achieve the above-mentioned object, the present invention is a high-pressure discharge lamp, which comprises a pair of electrodes that are separated from one another by a predetermined distance, and which is lighted by a reverse polarity power source, wherein this high-pressure discharge lamp is designed to satisfy a relationship whereby

$$1.5 \leq ( \frac{I}{π \cdot {r}^{2}} ) \leq 9 \qquad ( 1 )$$

when the radius at the tip of each electrode is r (mm), the lamp current at steady discharge is I (amperes), and the ratio of the circumference of the circle to its diameter is π.

### BRIEF DESCRIPTION OF THE DRAWINGS

FIG. 1A is a diagram showing a configuration for a metal halide lamp of a first embodiment of the present invention.

FIG. 1B is an enlarged diagram of the arc discharge portion in FIG. 1A.

FIG. 2A is a diagram showing a configuration for a high-pressure mercury lamp of a second embodiment of the present invention.

FIG. 2B is an enlarged diagram of the arc discharge portion in FIG. 2A.

### DESCRIPTION OF THE PREFERRED EMBODIMENTS

The following is a detailed description of the embodiments of the present invention based on the figures.

### Embodiment 1

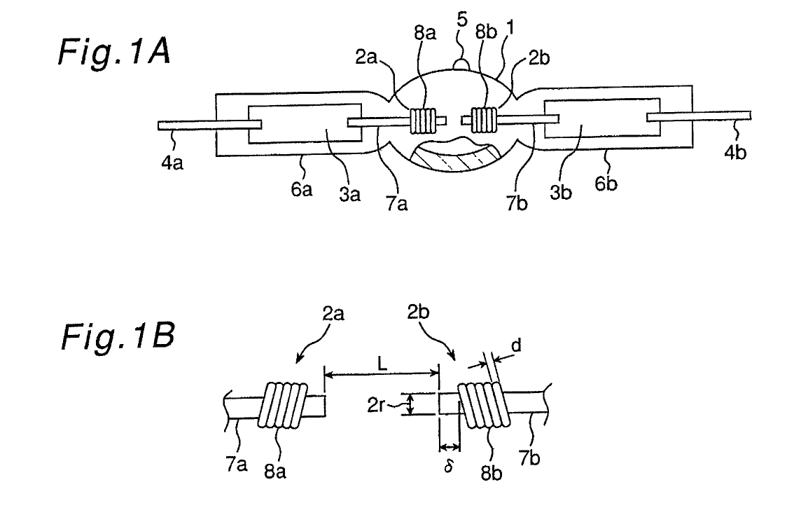

FIGS. 1A and 1B show a metal halide lamp of a first embodiment of a high-pressure discharge lamp according to the present invention.

In FIG. 1A, 1 is an arc tube, which is a translucent vessel made of quartz, on both ends of which are formed sealed portions 6a, 6b. Metal foil conductors made of molybdenum, molybdenum foil 3a, 3b, are sealed into each of the sealed portions 6a, 6b, and electrodes 2a, 2b and molybdenum external lead lines 4a, 4b are connected electrically to each of these metal foil conductors of molybdenum foil 3a, 3b.

As best shown in FIG. 1B, the respective electrodes 2a, 2b are configured from radius r=0.4 mm tungsten rods 7a, 7b, and coils 8a, 8b of 5 winds of closely wound tungsten wire having a diameter d=0.3 mm.

The respective coils 8a, 8b serve as radiators for the electrodes 2a, 2b, and are affixed electrically by welding to locations at the ends of the tungsten rods 7a, 7b so that the length of protrusion 8 of the tungsten rods 7a, 7b from the coils 8a, 8b becomes roughly 0.8 mm. And the electrodes 2a, 2b are positioned opposite one another inside the arc tube 1 so that the mutual clearance therebetween, that is, the distance between electrodes L, becomes 3 mm. The arc tube 1 is a truncated spheroid shape, with a maximum inner diameter of 10 mm at the center, and a content volume of 0.7 cc, and as filling, contains 0.4 mg of indium iodide (Inl), 1 mg of holmium iodide (Hol₃), 35 mg of mercury as a buffer gas, and 150 Torr of argon as a starting noble gas.

Reverse polarity power was supplied via external lead wires 4a, 4b to a metal halide lamp configured as above, and life testing was conducted when the arc was in a horizontal state under conditions wherein lamp current was 2.71 A (amperes) and lamp input was 200 W (watts) during steady discharge, and the luminous flux maintenance factor was checked after 500 hours. For the sake of comparison, the same life testing was performed on a lamp for which the radius of the tungsten rods 7a, 7b was r=0.27 mm, and the other configurations were the same as the metal halide lamp shown in FIG. 1A (hereinafter called lamp A), and a lamp for which the distance between electrodes L was 7 mm, the radius of the tungsten rods 7a, 7b was r=0.27 mm, and the other configurations were the same as the metal halide lamp shown in FIG. 1A (hereinafter called lamp B).

The results were that, after 500 hours, the lamp configured as shown in FIG. 1A, and lamp B exhibited little blackening of the arc tube and devitrification phenomenon, and the luminous flux maintenance factors thereof were also good. However, the blackening of lamp A was intense even though there was no devitrification of the arc tube.

From the results obtained from lamp A and lamp B, it is clear that blackening becomes intense when the arc length is shortened. The reason for this is because when the distance between the electrodes was shortened, and the lamps were lighted using the same lamp input, the power inputted per unit arc length increased, thereby raising the arc temperature, and increasing the heat transmitted to the electrodes 2a, 2b from the arc via radiation and conduction. As a result thereof, the thermal burden on the electrodes 2a, 2b increased, the temperature rose, and the diffusion of the tungsten, which comprises the electrodes 2a, 2b, became animated. Conversely, the lamp configuration of this embodiment shown in FIGS. 1A and 1B can be said to have electrodes 2a, 2b capable of withstanding increased thermal burden. In the case of the lamp configuration of FIGS. 1A and 1B, the equation becomes,

$$\frac{I}{π \cdot {r}^{2}} = \frac{2.71}{π \cdot {0.4}^{2}} = 5.4 ( π = 3.14 )$$

and this value satisfies formula (1) above.

Meanwhile, for lamp A, the equation becomes

$$\frac{I}{π \cdot {r}^{2}} = \frac{2.71}{π \cdot {0.27}^{2}} = 11.8 ( π = 3.14 )$$

and this value does not satisfy formula (1) above.

The results of testing conducted to find the range of preferred electrode shapes is described next. The lamps utilized in the testing were metal halide lamps with the same configuration as the lamp shown in FIGS. 1A and 1B. Only the structure of the electrodes 2a, 2b and the distance between electrodes L thereof were changed to study the effects on life characteristics. The contents and results of these tests are shown in (Table 1). The factors varied in the electrode structure 2a, 2b were the radius r (mm) of the tungsten rods 7a, 7b, and the diameter d (mm) of the tungsten wire comprising the coils 8a, 8b. Evaluations were determined by the degree of blackening of the arc tube following 500 hours of lighting. The length of protrusion 8 of the tungsten rods 7a, 7b from the coils 8a, 8b, the number of windings of the coils 8a, 8b, and the lighting conditions (lamp current I, lamp input) were the same as for the above embodiment.

TABLE 1

| | | | Tungsten | Distance | Evaluation |
|---|---|---|---|---|---|
| | | Tungsten | Wire | Between | Good = O |
| | | Rod Radius | Diameter | Electrodes | No |
| | Lamp No. | r (mm) | d (mm) | L (mm) | Good = X |
| Group A | 1 | 0.25 | 0.3 | 3 | X |
| | 2 | 0.31 | 0.3 | 3 | O |
| | 3 | 0.55 | 0.3 | 3 | O |
| | 4 | 0.65 | 0.3 | 3 | O |
| | 5 | 0.75 | 0.3 | 3 | O |
| | 6 | 0.85 | 0.3 | 3 | O |
| Group B | 7 | 0.31 | 0.2 | 3 | O |
| | 8 | 0.31 | 0.4 | 3 | O |
| | 9 | 0.31 | 0.5 | 3 | O |
| | 10 | 0.75 | 0.2 | 3 | O |
| | 11 | 0.75 | 0.4 | 3 | O |
| | 12 | 0.75 | 0.5 | 3 | O |
| Group C | 13 | 0.31 | 0.3 | 1.5 | O |
| | 14 | 0.31 | 0.3 | 4.5 | O |
| | 15 | 0.75 | 0.3 | 1.5 | O |
| | 16 | 0.75 | 0.3 | 4.5 | O |

For Group A (Lamp No. 1-No. 6) in (Table 1), the distance between electrodes was fixed at L=3 mm, the diameter of the tungsten wire comprising the coils 8a, 8b was fixed at d=0.3 mm, and the radius r of the tungsten rods 7a, 8b underwent various changes.

The results thereof were that tungsten rods 7a, 7b with an r of 0.31 mm or larger were good, exhibiting little blackening of the arc tube. By contrast, the r=0.25 mm (No. 1) tungsten rods 7a, 7b were too thin, diffusion of the tungsten electrode material during use was severe, and there was a marked drop in the luminous flux maintenance factor as a result of blackening.

From these results, it was concluded that the radius r of the tungsten rods 7a, 7b should be 0.31 mm or larger. However, although this range is good for suppressing blackening, in general, if the radius of the tungsten rods 7a, 7b is too large, the compressive strength of the sealed portions 6a, 6b decreases. The compressive strength exhibited by lamps No. 2-No.6 was measured using a separate test. Those results are shown in (Table 2).

TABLE 2

| | | | Compressive Strength |
|---|---|---|---|
| | | Tungsten Rod Radius | (Relative Value) With |
| | Lamp No. | r (mm) | Reference to Lamp No. 2 |
| Group A | 2 | 0.31 | 1 |
| | 3 | 0.55 | 0.95 |
| | 4 | 0.65 | 0.92 |
| | 5 | 0.75 | 0.80 |
| | 6 | 0.85 | 0.60 |

If we take into consideration the effect that the diameter of the tungsten rods 7a, 7b has on compressive strength based on the results listed in (Table 2), regulating r within the range of 0.31 mm to 0.80 mm should make it possible to ensure both sufficient compressive strength and adequate suppression of blackening. Even more desirable is a radius between 0.31 mm and 0.75 mm.

Furthermore, since tungsten rods 7a, 7b within this range are relatively thick, even with the addition/inclusion of bromine, or a metallic bromide, which bonds with low-temperature tungsten and causes tapering at the base of the electrode, electrode tapering is so slight as to not be a problem. Therefore, another effect is obtained, one which enables the addition/inclusion of bromine or a metallic bromide for the purpose of preventing the devitrification of the arc tube 1.

Diffusion of the electrode material is effected not only by the size of the radius r, but also by the lamp current I per unit area during steady discharge. Therefore, if the relationship between the radius r (mm) of the tungsten rods 7a, 7b and the lamp current I (amperes) is expressed using a general formula, from the above conclusion, it was learned that when the ratio of the circumference of the circle to its diameter is expressed as π, this formula is

$$\frac{I}{π \cdot {r}^{2}} ( lower limit value ) = \frac{2.71}{π \cdot {0.75}^{2}} = 1.5$$

$$\frac{I}{π \cdot {r}^{2}} ( upper limit value ) = \frac{2.71}{π \cdot {0.31}^{2}} = 9.0$$

so that

$$1.5 \leq \frac{I}{π \cdot {r}^{2}} \leq 9$$

and the relationship between I and r irrespective of lamp input (watts) can be satisfied as in the above formula.

Next, for Group B (Lamp No. 7-No. 12), the radius r of the tungsten rods 7a, 8b was set at the lower limit value of 0.31 mm and the upper limit value of 0.75 mm, the range over which the above-mentioned evaluation was good, and the diameter d of the tungsten wire comprising the coils 8a, 8b underwent various changes.

The results of this were good with blackening also being slight for all lamps (No.7-No.12). From this, it was concluded that so long as the diameter d of the tungsten wire comprising the coils 8a, 8b satisfies the above-described formula (1), there is no particular need for limits.

Next, for Group C (Lamp No. 13-No. 16), the radius r of the tungsten rods 7a, 8b was set at 0.31 mm and 0.75 mm, the diameter of the tungsten wire comprising the coils 8a, 8b was fixed at d=0.3 mm, and the distance between electrodes L underwent various changes.

The results were that the life characteristics of all the lamps were good. Therefore, it was learned that if the above-mentioned formula (1) is satisfied regardless of the distance between the electrodes, blackening can be suppressed even in a short-arc-type metal halide lamp wherein the distance between electrodes L is roughly between 1 mm and 5 mm.

Furthermore, if the relationship between the lamp current I and the radius r of the tungsten rods 7a, 7b is adjusted so as to satisfy the above-mentioned formula (1), needless to say, the blackening suppression effect can be adequately achieved even with a lamp in which the distance between electrodes L is greater than 5 mm.

Furthermore, testing of each of the above-mentioned groups was conducted using the single coil shown in FIG. 1B as the shape of the coils 8a, 8b. However, when further testing was carried out on a number of these test lamps using multiple windings, for example, double wind coils, or no coils at all, it was learned that the results did not change irrespective of the presence or absence of coils.

That is, lamps that were good with single coils, were also good with multiple coils and no coils, and lamps that were no good with single coils, were also no good with multiple coils and no coils.

Further, if the length of protrusion δ of the tungsten rods 7a, 7b from the coils 8a, 8b, and the number of windings of the coils 8a, 8b satisfied the above-mentioned formula (1), there is no particular need for limits.

From the above results, it was learned that if the radius r (mm) of the tungsten rods 7a, 7b, and the lamp current I (amperes) satisfy the formula

$$1.5 \leq \frac{I}{π \cdot {r}^{2}} \leq 9$$

when the ratio of the circumference of the circle to its diameter is expressed by π, a lamp that exhibits little blackening and good life characteristics can be achieved.

Further, the above embodiment was described using horizontal lighting as an example, but the present invention is not limited to this, and perpendicular lighting is also possible. Similarly, the metallic halogen compound filling is also not limited to that used in the above embodiment, and the same effect can be achieved even with halogen compounds such as neodymium (Nd) and cesium (Cs), dysprosium (Dy). Furthermore, the present invention is not limited to a metal halide lamp, and the same effect can be achieved with other high-pressure discharge lamps, such as a high-pressure mercury lamp, and a high-pressure sodium vapor lamp, for example.

### Embodiment 2

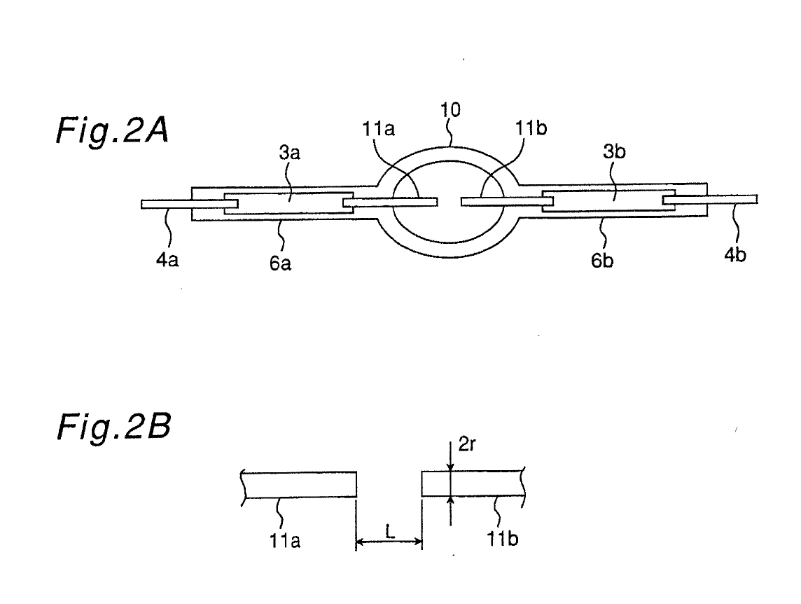

FIGS. 2A and 2B show a diagram of a second embodiment of a high-pressure mercury lamp according to the present invention.

In FIG. 2A, 10 is an arc tube, which is a translucent vessel made of quartz, the shape of which is a truncated spheroid, with a maximum inner diameter of 7 mm at the center, and a content volume of 0.25 cc, and as filling, it contains 35 mg of mercury, and roughly 3 atmospheres of xenon gas at room temperature.

As best shown in FIG. 2B, 11a, 11b are each tungsten rods with a radius of r=0.3 mm, and serve as electrodes. The tungsten rods 11a, 11b are positioned opposite one another inside the arc tube 10 so that the mutual clearance therebetween, that is, the distance between electrodes L, becomes 1.5 mm. The rest of the configuration is the same as the lamp shown in FIGS. 1A and 1B.

Reverse polarity power was supplied via external lead wires 4a, 4b to a lamp configured as above, and life testing was conducted when the arc was in a horizontal state under conditions wherein lamp current I was 1.1 A (amperes) and lamp input was 100 W (watts) during steady discharge. For a lamp configured as shown in FIGS. 2A and 2B, the formula becomes

$$\frac{I}{π \cdot {r}^{2}} = \frac{1.1}{π \cdot {0.3}^{2}} = 3.9 ( π = 3.14 )$$

and this value satisfies formula (1) above. As a result, good life characteristics were achieved without any sign of early blackening of the arc tube 10. Further, for the lamp configuration shown in FIGS. 2A and 2B as well, as a result of pursuing the preferred range of electrode shapes by varying the shape of the electrodes (tungsten rods 11a, 11b) similar to above, it was confirmed that similar effects are achieved if adjustments are made to satisfy formula (1) above. Furthermore, between 0.1 mg and 1 mg of mercury bromide (HgBr₂) was added to a lamp configured as shown in FIG. 2A, and life testing was conducted in the same manner. Good life characteristics were achieved without the occurrence of bromine-induced tapering of the tungsten rods 11a, 11b.

Further, the lamp was filled with roughly 3 atmospheres of xenon gas at room temperature. This was to increase the light output at initial lighting. Therefore, there is no limit range to the pressure thereof, and further, in place of xenon, for example, argon can also be used.

As for the tungsten rods 7a, 7b and 11a, 11b in the embodiments described above, in the formation process thereof, the cross-sections thereof often become substantially ellipsoidal rather than completely circular. When this happens, the radius r can be considered the average value of the lengths of the major axis and minor axis.

Further, if the tungsten rods 7a, 7b and 11a, 11b are comprised of a high-melting-point metallic material, which is superior even to tungsten in electron emissivity, for example, thoriated-tungsten, which contains thorium oxide, the diffusion of the electrode material can be further reduced, and blackening can also be suppressed.

The preferred embodiments of the present invention have been described above, but, needless to say, the present invention is not limited to this description, and all sorts of variations are possible.

As described above, since the present invention regulates the relationship between the radius of the tips of the electrodes and the lamp current during steady discharge in a high-pressure discharge lamp lighted by a reverse polarity power source, it enables the realization of a long-life, economical lamp, which exhibits little early blackening of the arc tube.

What is claimed is:

1. A high-pressure discharge lamp, comprising:
a sealed tube;
first and second electrodes extending into said sealed tube and separated from one another by a predetermined distance, said first and second electrodes being adapted for receiving reverse polarity electric power;
each of said first and second electrodes having a radius r (mm) at the tip thereof which satisfies the following relationship,
$$1.5 \leq \frac{I}{π \cdot {r}^{2}} \leq 9$$
wherein I (amperes) is a lamp current during steady discharge, and π is a ratio of the circumference of the circle to its diameter.

2. The high-pressure discharge lamp according to claim 1, further comprising any one of bromine and a metallic bromide compound in said sealed tube.

3. The high-pressure discharge lamp according to claims 1, wherein said first and second electrodes are separated from one another by a distance of between 1 mm and 5 mm.
